(19) United States
(12) Patent Application Publication
(10) Pub. No.: US 2014/0009935 A1
(43) Pub. Date: Jan. 9, 2014

(54) LIGHTING DEVICE

(71) Applicant: KABUSHIKI KAISHA TOSHIBA, Tokyo (JP)

(72) Inventors: Michinobu INOUE, Kanagawa-ken (JP); Yasuhide Okada, Kanagawa-ken (JP); Daigo Suzuki, Kanagawa-ken (JP)

(73) Assignee: Kabushiki Kaisha Toshiba, Tokyo (JP)

(21) Appl. No.: 13/832,789

(22) Filed: Mar. 15, 2013

(30) Foreign Application Priority Data
Jul. 9, 2012 (JP) 2012-153852

(51) Int. Cl. F21V 5/00; F21V 7/00

(52) U.S. Cl. CPC F21V 5/00; F21V 7/0091
USPC 362/235; 362/311.06; 362/307

(57) ABSTRACT

According to one embodiment, a lighting device includes a first light source, a body section and a light distribution section. The first light source includes a light emitting element. The body section includes an attachment portion on one end portion. The first light source is attached to the attachment portion. The light distribution section is provided on the end portion of the body section and injected with light radiated from the first light source. The light distribution section has a flat shape. A peripheral portion of the light distribution section in a direction orthogonal to a central axis of the lighting device protrudes from periphery of the end portion of the body section.

### CROSS-REFERENCE TO RELATED APPLICATIONS

This application is based upon and claims the benefit of priority from the prior Japanese Patent Application No.2012-153852, filed on Jul. 9, 2012; the entire contents of which are incorporated herein by reference.

### FIELD

Embodiments described herein relate generally to a lighting device.

### BACKGROUND

Recently, instead of incandescent bulbs (filament bulbs), lighting devices using light emitting diodes (LED) as a light source have been put to practical use.

Lighting devices using light emitting diodes as a light source have long lifetime and can reduce power consumption. Thus, such lighting devices are expected to replace existing incandescent bulbs.

Furthermore, there is proposed a ceiling light including a plurality of light emitting diodes, a light guide plate injected with light from the light emitting diodes, and a light deflection means for ejecting downward the light injected into the light guide plate.

In such lighting devices using light emitting diodes as a light source, there is demand for expanding the light distribution angle and improving the dissipation of heat generated in the light source.

### BRIEF DESCRIPTION OF THE DRAWINGS

FIGS. 1A and 1B are schematic views for illustrating a lighting device according to an embodiment;

FIGS. 2A and 2B are schematic views for illustrating the relationship between the shape of the globe and the light distribution angle;

FIG. 3 is a schematic sectional view for illustrating the expansion of the light distribution angle;

FIGS. 4A to 4C are schematic views for illustrating the heat distribution in the body section;

FIGS. 5A to 5D are schematic views for illustrating the layout of a plurality of light sources 3;

FIGS. 6A and 6B are schematic views for illustrating the angle θ between the central axis 1a of the lighting device 1 and the optical axis 3a1 of the light source 3;

FIGS. 7A and 7B are schematic views for illustrating the case of providing another light source 13 for radiating light in the central axis direction of the lighting device 1;

FIGS. 8A and 8B are graphs for illustrating light distribution characteristics;

FIG. 9 is a schematic sectional view for illustrating the surface state on the end portion 2a side of the body section 2; and

FIGS. 10A and 10B are schematic views for illustrating a lighting device 11 according to an alternative embodiment.

### DETAILED DESCRIPTION

According to one embodiment, a lighting device includes a first light source, a body section and a light distribution section. The first light source includes a light emitting element. The body section includes an attachment portion on one end portion. The first light source is attached to the attachment portion. The light distribution section is provided on the end portion of the body section and injected with light radiated from the first light source. The light distribution section has a flat shape. A peripheral portion of the light distribution section in a direction orthogonal to a central axis of the lighting device protrudes from periphery of the end portion of the body section.

Various embodiments will be illustrated hereinafter with reference to the accompanying drawings. In the drawings, similar components are labeled with like reference numerals, and the detailed description thereof is omitted appropriately.

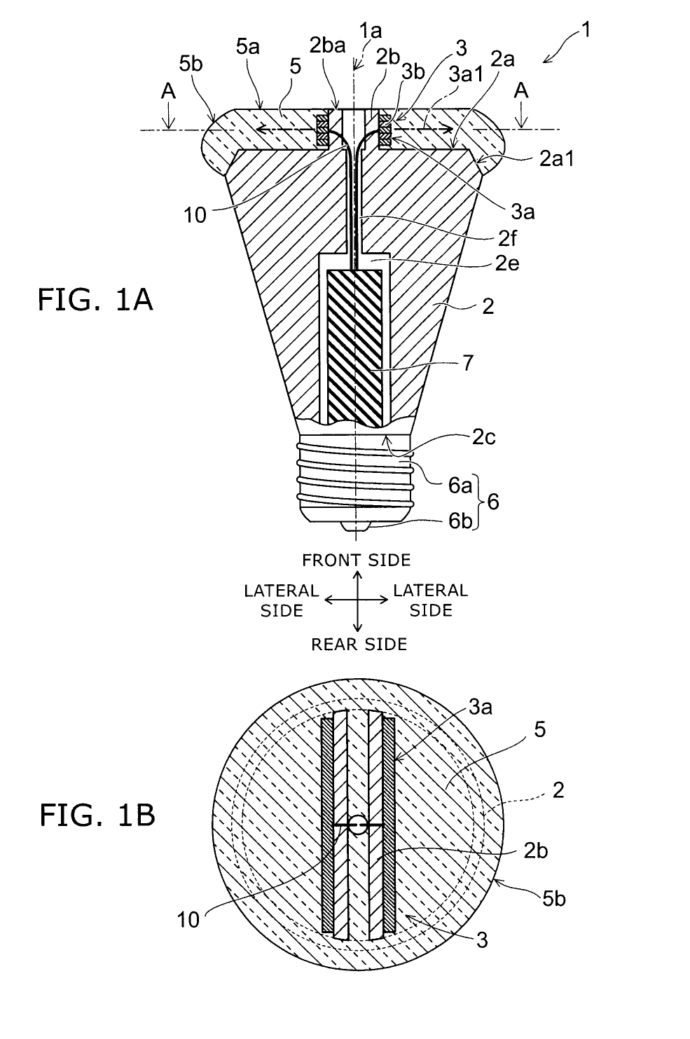

FIGS. 1A and 1B are schematic views for illustrating a lighting device according to an embodiment.

FIG. 1A is a schematic partial sectional view of the lighting device. FIG. 1B is a sectional view taken in the direction of arrows A-A in FIG. 1A.

As shown in FIG. 1A, the lighting device 1 includes a body section 2, a light source 3 (corresponding to an example of the first light source), a light distribution section 5, a base section 6, and a control section 7.

The body section 2 can be shaped so that, for instance, the cross-sectional area in the direction (lateral direction of the lighting device 1) orthogonal to the central axis 1a of the lighting device 1 gradually increases from the base section 6 side toward the light distribution section 5 side. However, the shape is not limited thereto. For instance, the shape can be appropriately changed depending on e.g. the size of the light source 3, the light distribution section 5, and the base section 6. In this case, the shape can be made approximate to the shape of the neck portion of an incandescent bulb. This can facilitate replacement for existing incandescent bulbs.

The body section 2 can be formed from e.g. a material having high thermal conductivity. The body section 2 can be formed from e.g. a metal such as aluminum (Al), copper (Cu), and an alloy thereof. However, the material is not limited thereto. The body section 2 can also be formed from e.g. an inorganic material such as aluminum nitride (AlN) and aluminum oxide (Al₂O₃), or an organic material such as high thermal conductivity resin.

An inclined portion 2a1 is provided at the periphery of one end portion 2a of the body section 2.

The inclined portion 2a1 is inclined in the direction in which the end portion 2a side of the body section 2 comes close to the center side of the body section 2.

Furthermore, the end portion 2a is provided with an attachment portion 2b to which the light source 3 is attached.

By attaching the light source 3 to the attachment portion 2b, the axis 3a1 (hereinafter referred to as optical axis 3a1) perpendicular to the radiation surface 3a of the light source 3 is directed in a direction crossing the central axis 1a of the lighting device 1.

In the example illustrated in FIG. 1A, the optical axis 3a1 is directed in the direction (lateral direction of the lighting device 1) orthogonal to the central axis 1a of the lighting device 1.

The light source 3 can be configured to have e.g. a plurality of light emitting elements 3b. However, the number of light emitting elements 3b can be appropriately changed. One or more light emitting elements 3b can be provided depending on e.g. the purpose of the lighting device 1 and the size of the light emitting element 3b.

The light emitting element 3b can be e.g. what is called a self-emitting element such as a light emitting diode, organic light emitting diode, and laser diode. In the case where a plurality of light emitting elements 3b are provided, they can be provided in a regular arrangement pattern such as a matrix, staggered, and radial pattern, or in an arbitrary arrangement pattern.

The light distribution section 5 is provided on one end portion 2a of the body section 2.

The light distribution section 5 is injected with light radiated from the light source 3.

The light distribution section 5 has a flat shape.

The end surface 5a of the light distribution section 5 on the opposite side from the side provided on the end portion 2a is a flat surface parallel to the end portion 2a.

Alternatively, the end surface 5a can be configured to have a convex curved surface protruding to the front side of the lighting device 1.

However, as described later, if the end surface 5a is configured to be a flat surface, light can be easily radiated toward the front side of the lighting device 1. This can increase the intensity of light on the front side of the lighting device 1.

The peripheral portion 5b of the light distribution section 5 located in the direction (lateral direction of the lighting device 1) orthogonal to the central axis 1a of the lighting device 1 protrudes from the periphery of the end portion 2a of the body section 2.

The peripheral portion 5b has a curved surface convex in the direction protruding from the periphery of the body section 2.

The light distribution section 5 is translucent so that the injected light can be radiated to the outside of the lighting device 1. The light distribution section 5 can be formed from a translucent material. For instance, the light distribution section 5 can be formed from e.g. glass, transparent resin such as polycarbonate, or translucent ceramic.

The light distribution section 5 can be brought into contact with the radiation surface 3a of the light source 3. Alternatively, a gap can be provided between the light distribution section 5 and the radiation surface 3a of the light source 3. A gap provided between the light distribution section 5 and the radiation surface 3a of the light source 3 can suppress alteration and deformation of the light distribution section 5 by heat generated in the light source 3.

The base section 6 is provided on the end portion 2c of the body section 2 on the opposite side from the side provided with the light distribution section 5. The base section 6 can be configured to have a shape attachable to the socket for receiving an incandescent bulb. The base section 6 can be configured to have a shape similar to e.g. E26 or E17 specified by the JIS standard. However, the base section 6 is not limited to the shape illustrated, but can be appropriately changed. For instance, the base section 6 can also be configured to have pin-shaped terminals used for a fluorescent lamp, or an L-shaped terminal used for a ceiling hook.

The base section 6 can be formed from e.g. a conductive material such as metal. Alternatively, the portion electrically connected to the external power supply can be formed from a conductive material such as metal, and the remaining portion can be formed from e.g. resin.

The base section 6 illustrated in FIG. 1A includes a cylindrical shell portion 6a having a screw thread, and an eyelet portion 6b provided on the end portion of the shell portion 6a on the opposite side from the end portion provided on the body section 2. To the shell portion 6a and the eyelet portion 6b, the control section 7 described later is electrically connected. This enables the control section 7 to be electrically connected to the external power supply, not shown, through the shell portion 6a and the eyelet portion 6b. Here, in the case where the body section 2 is formed from e.g. metal, an insulating section formed by curing e.g. an adhesive can be provided between the body section 2 and the base section 6.

The control section 7 is provided in a space 2e formed inside the body section 2.

One end portion of a hole portion 2f opens in the front side end surface 2ba of the attachment portion 2b. The other end portion of the hole portion 2f opens in the space 2e provided with the control section 7.

By a wiring 20 passed inside the hole portion 2f, the light source 3 and the control section 7 are electrically connected.

An insulating section, not shown, for electrical insulation can be appropriately provided between the body section 2 and the control section 7.

The control section 7 can be configured to have a lighting circuit for supplying electrical power to the light source 3. In this case, the lighting circuit can be configured, for instance, to convert the AC 100 V commercial power to DC and to supply it to the light source 3. Furthermore, the control section 7 can also be configured to have a dimming circuit for dimming the light source 3. Here, in the case where a plurality of light emitting elements 3b are provided, the dimming circuit can be configured to perform dimming for each light emitting element 3b, or for each group of light emitting elements 3b.

Here, when the light emitting elements 3b are used for the light source 3, the problem is that the light distribution angle is narrower than that of the incandescent bulb. In this case, if the shape of the light distribution section 5 is made close to a full sphere, the light distribution angle can be expanded. However, as described later, if the shape of the light distribution section 5 is made close to a full sphere, the size of the body section 2 is made small. Then, heat dissipation through the body section 2 alone may fail to achieve a sufficient cooling effect.

Furthermore, heat generated in the light source 3 is dissipated to the outside primarily through the body section 2.

Thus, in such cases as increasing the electrical power inputted to the light source 3 to further increase the luminous flux of the lighting device 1, it is necessary to increase the amount of heat dissipation through the body section 2.

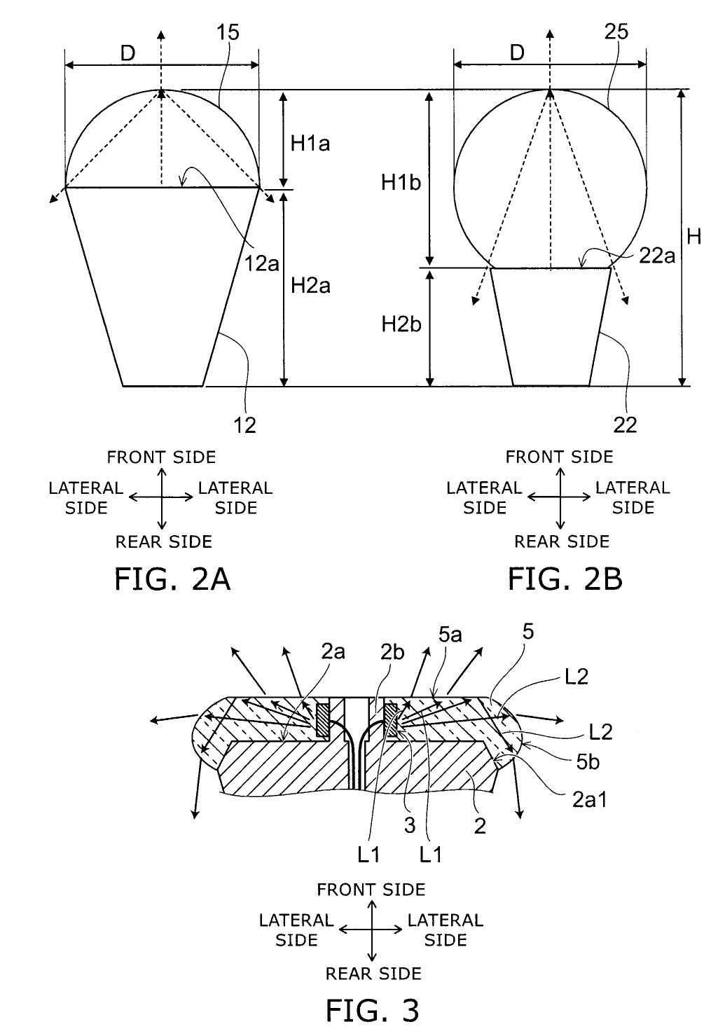

FIGS. 2A and 2B are schematic views for illustrating the relationship between the shape of the globe and the light distribution angle.

The globe 15, 25 is a hollow cover provided so as to cover the end portion 12a, 22a of the body section 12, 22. The light radiated from the light source 3 is radiated to the outside of the lighting device through the globe 15, 25.

FIG. 2A shows the case where the shape of the globe 15 is a hemisphere. FIG. 2B shows the case where the shape of the globe 25 is close to a full sphere.

The arrows in the figures represent the traveling direction of light. Here, to avoid complexity, typical directions necessary for describing the light distribution angle are shown.

Here, in view of replacement for existing incandescent bulbs, preferably, the outline dimensions of the lighting device are equal to those of the incandescent bulb as much as possible. Thus, in FIGS. 2A and 2B, the diameter dimension D of the globe 15, 25 and the height dimension H of the lighting device are made nearly equal to the dimensions of the counterparts of the incandescent bulb.

As shown in FIG. 2B, if the shape of the globe 25 is made close to a full sphere, the light can be radiated to the rear side further than in the case of the hemispherical globe 15 shown in FIG. 2A. Thus, the light distribution angle can be expanded.

However, if the shape of the globe 25 is made close to a full sphere, the height dimension H1b of the globe 25 is made larger than the height dimension H1a of the globe 15. On the other hand, the height dimension H of the light device is fixed. Thus, the height dimension H2b of the body section 22 is made smaller than the height dimension H2a of the body section 12. That is, if the shape of the globe 25 is made close to a full sphere to expand the light distribution angle, the size of the body section 22 is made small. This may hamper the heat dissipation through the body section 22.

As described above, expanding the light distribution angle may deteriorate the dissipation of heat generated in the light source 3.

On the other hand, improving the dissipation of heat generated in the light source 3 may narrow the light distribution angle.

Thus, in the embodiment, the light distribution section 5 is provided to expand the light distribution angle and to improve the dissipation of heat generated in the light source 3.

First, the expansion of the light distribution angle is illustrated.

FIG. 3 is a schematic sectional view for illustrating the expansion of the light distribution angle.

As shown in FIG. 3, the end surface 5a of the light distribution section 5 on the opposite side from the side provided on the end portion 2a is a flat surface.

Thus, the light L1 directed from the light source 3 toward the front side of the lighting device 1 can be efficiently radiated to the front side of the lighting device 1.

Furthermore, the peripheral portion 5b of the light distribution section 5 located in the direction (lateral direction of the lighting device 1) orthogonal to the central axis 1a of the lighting device 1 protrudes from the periphery of the end portion 2a of the body section 2.

The peripheral portion 5b has a curved surface convex in the direction protruding from the periphery of the body section 2.

Thus, the light L2 injected into the peripheral portion 5b can be efficiently radiated to the lateral side and rear side of the lighting device 1.

Furthermore, an inclined portion 2a1 is provided at the periphery of one end portion 2a of the body section 2.

The inclined portion 2a1 is inclined in the direction in which the end portion 2a side of the body section 2 comes close to the center side of the body section 2.

Thus, light can be easily radiated to the rear side of the lighting device 1. This can increase the intensity of light on the rear side of the lighting device 1.

As described above, the light distribution section 5 having the aforementioned configuration is provided. Then, light can be efficiently radiated to the front side, lateral side, and rear side of the lighting device 1.

Thus, the light distribution angle of the lighting device 1 can be expanded.

Next, the improvement of the dissipation of heat generated in the light source 3 is illustrated.

As described with reference to FIGS. 2A and 2B, heat dissipation can be improved by increasing the height dimension of the body section 2.

Here, the light distribution section 5 has a flat shape. Thus, the height dimension of the body section 2 can be increased.

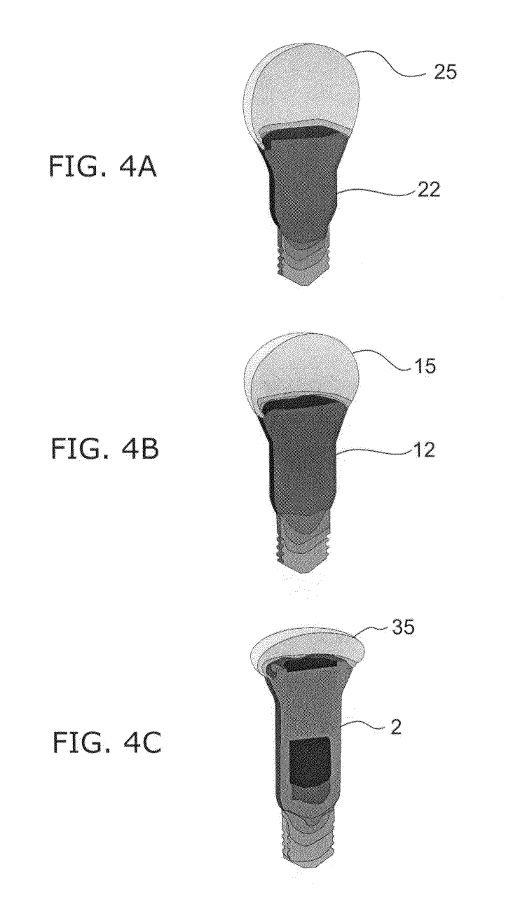

FIGS. 4A to 4C are schematic views for illustrating the heat distribution in the body section.

FIG. 4A shows the case of a lighting device including a full-spherical globe 25 illustrated in FIG. 2B. FIG. 4B shows the case of a lighting device including a hemispherical globe 15 illustrated in FIG. 2A. FIG. 4C shows the case of a lighting device including a globe 35 illustrated having the same height dimension as the light distribution section 5.

The temperature distribution is represented by monotone shading, with a higher temperature shaded darker and a lower temperature shaded lighter.

As shown in FIGS. 4A to 4C, as the height dimension of the globe becomes smaller, i.e., as the height dimension of the body section becomes larger, the temperature of the body section can be decreased.

This means that as the height dimension of the body section becomes larger, the heat dissipation performance is enhanced.

Here, if the heat dissipation performance can be enhanced, higher electrical power can be inputted to the light source 3. Thus, the luminous flux can be increased.

For instance, if the electrical power inputted to the light source 3 is 6.7 W in FIG. 4A, the input electrical power resulting in the same temperature as the body section 22 in FIG. 4A is 7.2 W in the case of FIG. 4B, and 7.8 W in the case of FIG. 4C.

As can be seen from the foregoing, by providing the light distribution section 5 having a flat shape and having a small height dimension, the dissipation of heat generated in the light source 3 can be improved.

This also means that the luminous flux of the lighting device 1 can be increased.

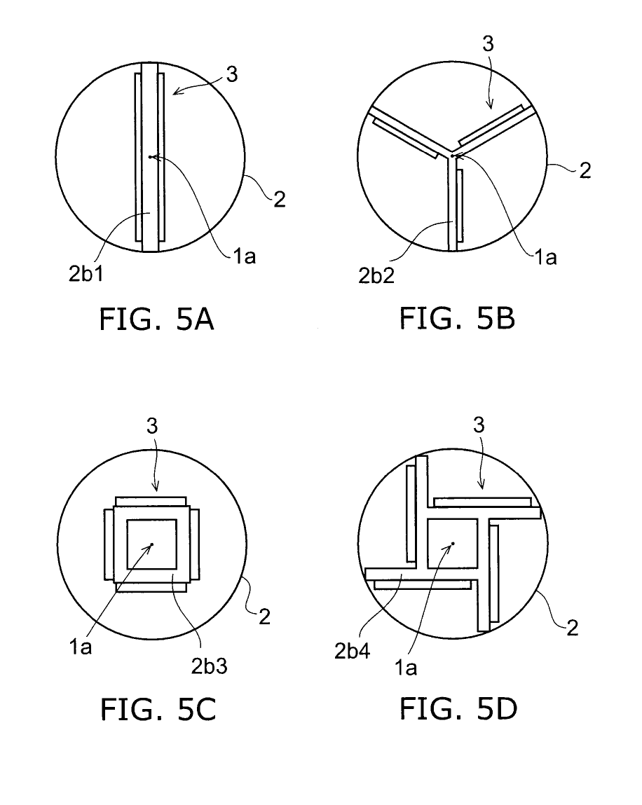

FIGS. 5A to 5D are schematic views for illustrating the layout of a plurality of light sources 3.

As shown in FIGS. 5A to 5D, a plurality of light sources 3 can be provided at positions rotationally symmetric about the central axis 1a of the lighting device 1.

For instance, attachment portions 2b1-2b4 can be provided at positions rotationally symmetric about the central axis 1a of the lighting device 1, and light sources 3 can be attached to the attachment portions 2b1-2b4.

This can improve the symmetry of light distribution with respect to the central axis 1a of the lighting device 1. Furthermore, the light sources 3 are distributively arranged. This can also improve the heat dissipation.

The number and layout of the light sources 3 and the shape and layout of the attachment portions 2b1-2b4, for instance, are not limited to those illustrated, but can be appropriately changed.

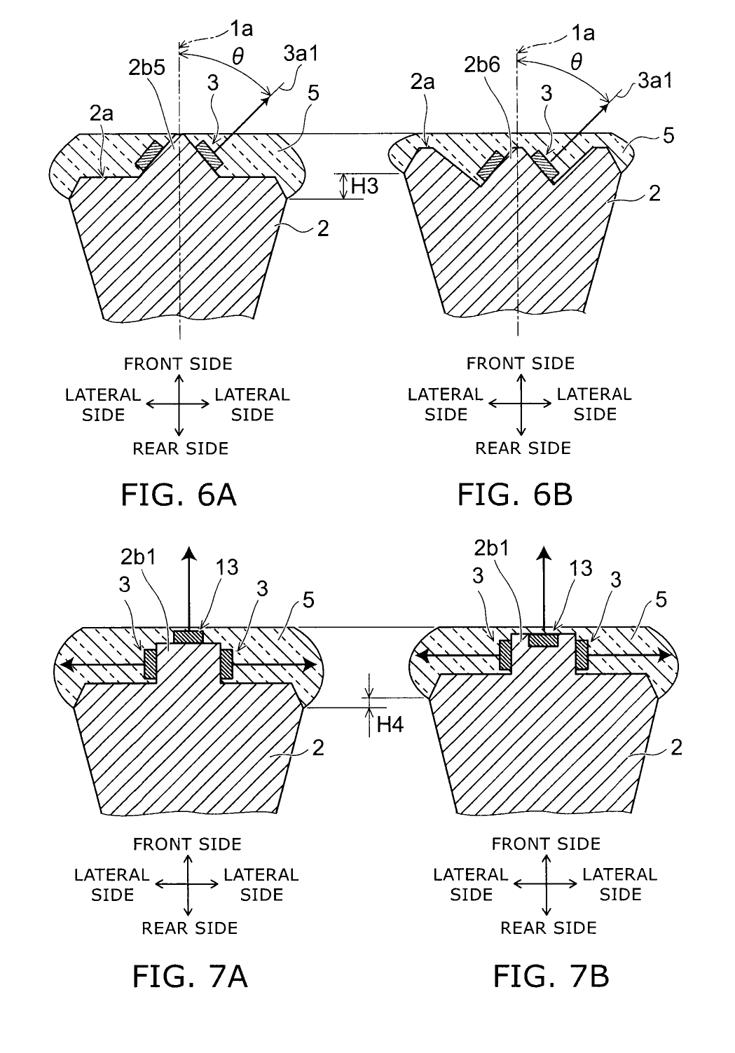

FIGS. 6A and 6B are schematic views for illustrating the angle θ between the central axis 1a of the lighting device 1 and the optical axis 3a1 of the light source 3.

The example illustrated in FIG. 1A shows the case where the angle θ between the central axis 1a of the lighting device 1 and the optical axis 3a1 of the light source 3 is 90°. However, the angle θ can be set to more than 0° and 90° or less (0°<θ≦90°).

Here, if the angle θ is made close to 0°, light can be easily radiated to the front side of the lighting device 1. This can increase the intensity of light on the front side of the lighting device 1.

On the other hand, if the angle θ is made close to 90°, light can be easily radiated to the lateral side and rear side of the lighting device 1. This can increase the intensity of light on the lateral side and rear side of the lighting device 1.

Thus, the angle θ can be appropriately changed depending on the light distribution characteristics required for the lighting device 1.

The light source 3 can be provided on the front side as viewed from the end portion 2a of the body section 2 as shown in FIGS. 1A and 6A. Alternatively, the light source 3 can be provided on the rear side as viewed from the end portion 2a of the body section 2 as shown in FIG. 6B.

In the case where the light source 3 is provided on the front side as viewed from the end portion 2a of the body section 2, a convex attachment portion 2b, 2b5 can be provided on the end portion 2a, and the light source 3 can be attached to the attachment portion 2b, 2b5.

In the case where the light source 3 is provided on the rear side as viewed from the end portion 2a of the body section 2, a concave attachment portion 2b6 can be provided on the end portion 2a, and the light source 3 can be attached to the attachment portion 2b6.

Here, in the case where the light source 3 is provided on the rear side as viewed from the end portion 2a of the body section 2, the angle θ between the central axis 1a of the lighting device 1 and the optical axis 3a1 of the light source 3 can be set to more than 0° and approximately 45° or less.

In the case where the light source 3 is provided on the front side as viewed from the end portion 2a of the body section 2, light can be easily radiated to the lateral side and rear side. This facilitates expanding the light distribution angle.

On the other hand, in the case where the light source 3 is provided on the rear side as viewed from the end portion 2a of the body section 2, the height dimension of the portion of the body section 2 exposed to the outside air can be increased. For instance, in the examples illustrated in FIGS. 6A and 6B, the height dimension of the portion of the body section 2 exposed to the outside air can be increased by dimension H3. This facilitates improving the heat dissipation.

FIGS. 7A and 7B are schematic views for illustrating the case of providing another light source 13 (corresponding to an example of the second light source) for radiating light in the central axis direction (to the front side) of the lighting device 1.

The light source 13 can be configured to have a configuration similar to that of the light source 3.

However, the number and the like of the light emitting elements 3b included in the light source 13 can be appropriately changed depending on the light distribution characteristics required for the lighting device 1, and the purpose and the like of the lighting device 1.

The light source 13 can be provided so that, for instance, the intensity of light on the front side of the lighting device 1 is made equal to the intensity of light on the lateral side of the lighting device 1 as much as possible.

Furthermore, the light source 13 can be provided in the case where, for instance, depending on the purpose of the lighting device 1, the intensity of light on the front side needs to be increased.

In this case, as shown in FIG. 7A, the light source 13 can be attached to the front side end surface of the attachment portion 2b1.

Alternatively, as shown in FIG. 7B, a recess can be provided in the front side end surface of the attachment portion 2b1, and the light source 13 can be attached inside the recess.

If a recess is provided in the front side end surface of the attachment portion 2b1, and the light source 13 is attached inside the recess, then the height dimension of the portion of the body section 2 exposed to the outside air can be increased. For instance, in the examples illustrated in FIGS. 7A and 7B, the height dimension of the portion of the body section 2 exposed to the outside air can be increased by dimension H4. This facilitates improving the heat dissipation.

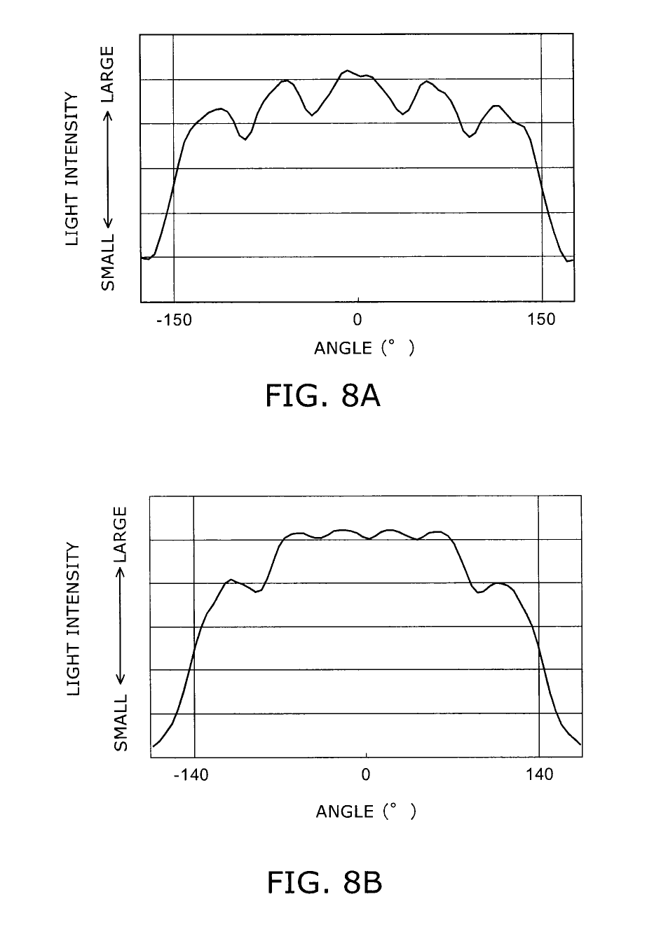

FIGS. 8A and 8B are graphs for illustrating light distribution characteristics.

FIG. 8A shows the case where four light sources 3 are provided as illustrated in FIG. 5D, and the angle θ between the central axis 1a of the lighting device 1 and the optical axis 3a1 of the light source 3 is set to 45°.

As shown in FIG. 8A, the angle for which the intensity of light is half or more of the maximum can be set to approximately 300° (approximately 150° on one side). That is, the light distribution angle can be expanded to approximately ±150° in terms of half-value angle.

FIG. 8B shows the case where four light sources 3 are provided as illustrated in FIG. 5D, the angle θ between the central axis 1a of the lighting device 1 and the optical axis 3a1 of the light source 3 is set to 90°, and the light source 13 is further provided as illustrated in FIG. 7A.

As shown in FIG. 8B, the angle for which the intensity of light is half or more of the maximum can be set to approximately 280° (approximately 140° on one side). That is, the light distribution angle can be expanded to approximately ±140° in terms of half-value angle.

Furthermore, the intensity of light on the front side of the lighting device 1 can be increased.

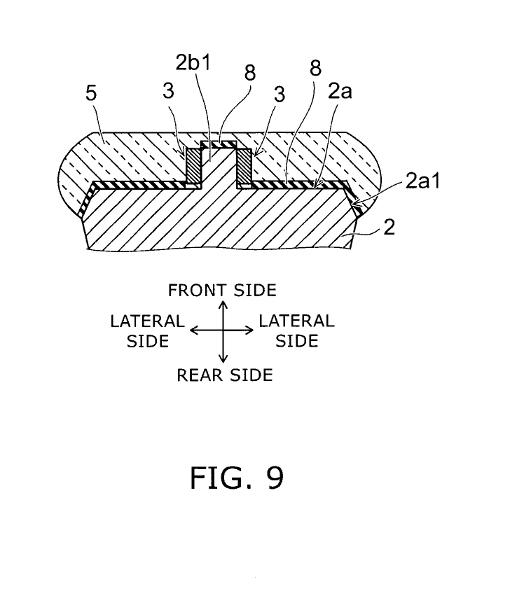

FIG. 9 is a schematic sectional view for illustrating the surface state on the end portion 2a side of the body section 2.

Part of the light radiated from the light source 3 is incident on the surface on the end portion 2a side of the body section 2. Then, the light incident on the surface on the end portion 2a side of the body section 2 is reflected.

Thus, if a reflecting layer 8 is provided on the surface of the end portion 2a of the body section 2 as shown in FIG. 9, the light extraction efficiency can be increased.

The reflecting layer 8 is provided on the surface of the end portion 2a of the body section 2, and reflects the incident light.

The reflecting layer 8 can be e.g. a layer formed by coating with a white paint.

In this case, the paint used for white coating is preferably configured to have resistance to heat generated in the lighting device 1 and resistance to light radiated from the light source 3. Examples of such a paint can include polyester resin-based white paint, acrylic resin-based white paint, epoxy resin-based white paint, silicone resin-based white paint, and urethane resin-based white paint containing at least one or more of white pigments such as titanium oxide (TiO₂), zinc oxide (ZnO), barium sulfate (BaSO₄), and magnesium oxide (MgO), or a combination of two or more white paints selected therefrom.

In this case, polyester-based white paint and silicone resin-based white paint are more preferable.

Alternatively, the reflecting layer 8 can be e.g. a layer formed by affixing a resin containing the aforementioned pigment on the surface of the end portion 2a of the body section 2.

Examples of the resin containing the aforementioned pigment can include polyester resin-based white resin, acrylic resin-based white resin, epoxy resin-based white resin, silicone resin-based white resin, urethane resin-based white resin, or a combination of two or more white resins selected therefrom.

In this case, polyester-based white resin and silicone resin-based white resin are more preferable.

However, the reflecting layer 8 is not limited thereto. For instance, the reflecting layer 8 can be formed by coating the body section 2 with a metal having high reflectance such as silver and aluminum using e.g. plating, evaporation, or sputtering technique. Alternatively, the reflecting layer 8 can be formed by laminating the body section 2 with a metal having high reflectance such as silver and aluminum using cladding technique.

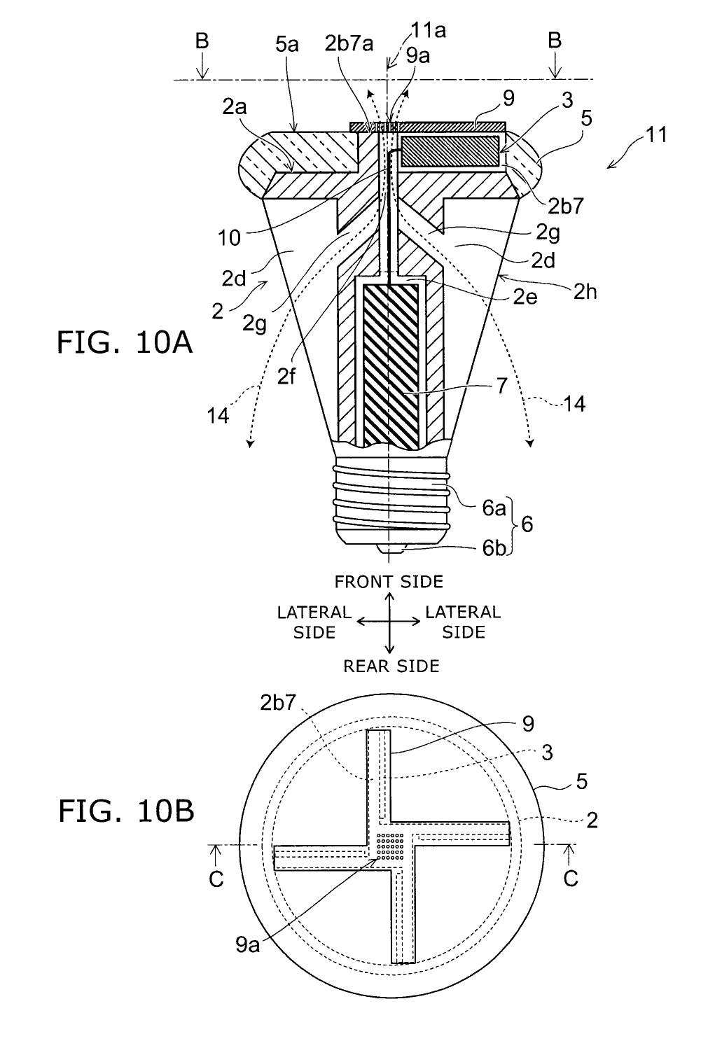

FIGS. 10A and 10B are schematic views for illustrating a lighting device 11 according to an alternative embodiment.

FIG. 10A is a partial sectional view taken in the direction of arrows C-C in FIG. 10B. FIG. 10B is a view taken in the direction of arrows B-B in FIG. 10A.

As shown in FIGS. 10A and 10B, the light source 3 is attached to an attachment portion 2b7.

One end portion of a hole portion 2f opens in the front side end surface 2b7a of the attachment portion 2b7. The other end portion of the hole portion 2f opens in the space 2e provided with the control section 7.

As described above, the hole portion 2f can be used as a hole for passing a wiring 10.

As shown in FIG. 10A, a plurality of grooves 2d opening in the surface 2h of the body section 2 (side surface of the body section 2) in the direction orthogonal to the central axis 11a of the lighting device 11 are provided.

The portion between the grooves 2d constitutes a heat dissipation fin.

One end portion of a hole portion 2g opens in the hole portion 2f. The other end portion of the hole portion 2g opens in the groove 2d. That is, hole portions (hole portion 2f and hole portion 2g) are configured so that one end portion opens on the end portion 2a side of the body section 2 and the other end portion opens in the groove 2d.

This can form an air flow 14 flowing inside the lighting device 11.

As a result, the dissipation of heat generated in the light source 3 can be further improved.

Furthermore, a cover 9 is provided on the end surface 5a of the light distribution section 5 on the opposite side from the side provided on the end portion 2a.

As shown in FIG. 10B, the cover 9 is provided so as to cover the attachment portion 2b7 and the light source 3 in plan view.

The material of the cover 9 is not particularly limited. The material of the cover 9 can be e.g. a resin material.

At the position of the cover 9 corresponding to the opening of the hole portion 2f, a plurality of hole portions 9a penetrating through the thickness direction of the cover 9 are provided.

The cross-sectional dimension of the hole portion 9a is not particularly limited. The cross-sectional dimension of the hole portion 9a can be set to a size enough to suppress intrusion of dust and the like into the lighting device 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A lighting device comprising:
a first light source including a light emitting element;
a body section including an attachment portion on one end portion, the first light source being attached to the attachment portion; and
a light distribution section provided on the end portion of the body section and injected with light radiated from the first light source,
the light distribution section having a flat shape, and
a peripheral portion of the light distribution section in a direction orthogonal to a central axis of the lighting device protruding from periphery of the end portion of the body section.

2. The device according to claim 1, wherein the peripheral portion has a curved surface convex in the protruding direction.

3. The device according to claim 1, wherein an end surface of the light distribution section on an opposite side from a side provided on the end portion of the body section is a flat surface.

4. The device according to claim 1, wherein a gap is provided between the light distribution section and a radiation surface of the first light source.

5. The device according to claim 1, wherein the light distribution section includes a translucent material.

6. The device according to claim 1, wherein the light distribution section includes at least one selected from the group consisting of glass, transparent resin, and translucent ceramic.

7. The device according to claim 1, wherein
an inclined portion is provided at the periphery of the end portion of the body section, and
the inclined portion is inclined in a direction in which the end portion side of the body section comes close to a center side of the body section.

8. The device according to claim 1, further comprising:
a second light source configured to radiate light in the central axis direction of the lighting device.

9. The device according to claim 8, wherein
the attachment portion includes a recess, and
the second light source is provided in the recess.

10. The device according to claim 1, wherein the attachment portion has a concave shape.

11. The device according to claim 1, further comprising:
a reflecting layer provided on a surface of the end portion of the body section and configured to reflect incident light.

12. The device according to claim 11, wherein the reflecting layer includes at least one selected from the group consisting of titanium oxide, zinc oxide, barium sulfate, and magnesium oxide.

13. The device according to claim 11, wherein the reflecting layer includes at least one selected from the group consisting of polyester resin-based white resin, acrylic resin-based white resin, epoxy resin-based white resin, silicone resin-based white resin, and urethane resin-based white resin.

14. The device according to claim 1, further comprising:
a plurality of grooves opening in a surface of the body section in a direction orthogonal to the central axis of the lighting device.

15. The device according to claim 14, further comprising:
a hole portion with one end portion opening on the end portion side of the body section and one other end portion opening in the groove.

16. The device according to claim 1, wherein
the first light source is provided in a plurality, and
the plurality of the first light sources are provided at positions rotationally symmetric about the central axis of the lighting device.

17. The device according to claim 1, wherein an angle between the central axis of the lighting device and an optical axis of the first light source is more than 0° and 90° or less.

18. The device according to claim 1, wherein an angle between the central axis of the lighting device and an optical axis of the first light source is more than 0° and 90° or less.

19. The device according to claim 1, further comprising:
a cover provided on an end surface of the light distribution section on an opposite side from a side provided on the end portion of the body section.

20. The device according to claim 19, wherein the cover is provided so as to cover the attachment portion and the light source in plan view.
